(19) United States
(12) Patent Application Publication
(10) Pub. No.: US 2012/0048290 A1
(43) Pub. Date: Mar. 1, 2012

(54) DISPENSING APPARATUS

(76) Inventor: Frank Anthony Cappello, Marina del Ray, CA (US)

(21) Appl. No.: 13/216,484

(22) Filed: Aug. 24, 2011

Related U.S. Application Data
(60) Provisional application No. 61/376,302, filed on Aug. 24, 2010.

(51) Int. Cl. A45D 40/18; A45D 42/00; A45D 40/00; B05C 17/01

(52) U.S. Cl. 132/218; 222/390; 132/316; 132/317

(57) ABSTRACT

A dispensing apparatus configured to contain a dispensable product and facilitate the storage and dispensing thereof. The dispensing apparatus includes a flat elongated housing configured to house a dispensable product within an interior chamber therein. The dispensing apparatus includes a minor-like finish disposed on an exterior surface of the housing. The dispensing apparatus includes a dispensing mechanism and configured to selectably urge product stored within the interior chamber out of the housing. The dispensing mechanism includes a dispensing nozzle. The dispensing apparatus includes a cap coupled at a dispensing end of the housing and configured to selectably cover and uncover the dispensing end. The dispensing apparatus includes an attachment structure disposed on an end of the housing and configured to selectably attach to a coupling member. The dispensing apparatus includes a container having an array of coupling member configured to selectably couple to a plurality of dispensing apparatuses.

### CROSS-REFERENCE TO RELATED APPLICATIONS

This invention claims priority, under 35 U.S.C. §120, to the U.S. Provisional Patent Application No. 61/376,302 to Frank Cappello filed on Aug. 24, 2010, which is incorporated by reference herein.

### BACKGROUND OF THE INVENTION

1. Field of the Invention

The present invention relates to cosmetic cases, specifically to a cosmetic dispensing apparatus.

2. Description of the Related Art

A compact is a cosmetic product. It is usually contained in a small, round case, with two or all of the following: a minor, pressed powder, and a powder puff. Eventually the more elaborate compact, the ‘vanity case’ became popular as it had more compartments for more makeup items such as eyeliners, lip gloss, lip stock, mascara applicators, perfume, concealers, blush, powders, creams, makeup, etc. Some improvements have been made in the field. Examples of references related to the present invention are described below in their own words, and the supporting teachings of each reference are incorporated by reference herein:

U.S. Pat. No. 7,204,256, issued to Abergel, discloses a packaging device for a product, preferably a make-up product, including a support generally planar in shape and in the form of a plate having two faces. The support includes at least one cavity having a depth less than or equal to the thickness of the plate, with the cavity opening on at least one face of the support at a first aperture, and with the cavity containing the product. The device includes an applicator for the product which is connected to the support by a junction area that can be broken to detach the applicator from the support. In addition, or alternatively, an adhesive sheet can be attached to the support, with a portion of the sheet forming a housing for the applicator.

U.S. Pat. No. 6,050,418, issued to Kohler, discloses a storage case for cosmetics and contact lenses is disclosed. The lens case has a front member and a rear member in which the front and rear members have an interior surface and an exterior surface and a top edge and a bottom edge and two side edges. The front member and rear member are hingedly connected together at one of the side edges and the remaining side edges are unconnected to each other but in contact with each other when the case is in a closed condition. The case is retained in a closed condition by a receptacle that is positioned within the case and the case is in an open condition when the receptacle is removed from within the case.

U.S. Pat. No. 5,163,457, issued to Lombardi Jr., discloses a travel compact for housing a cosmetic supply and a mirror, both of which in a storage mode of the compact are encased therein, the supply and the mirror being both exposed in a utility mode whereby the user may then view her face as she applies the cosmetic thereto. The compact includes a small rectangular case having an open front end and a top wall whose front section has an open window therein. Slidable in the case through its open end is a drawer whose top wall includes in its rear section a shallow well having a mirror nested therein, a front section on which is printed identifying indicia and a deeper well intermediate the front and rear sections in which a cosmetic supply is stored. In the storage mode, the drawer is pushed fully within the case, the window in the case being then closed by the front section of the drawer to expose the indicia through the window. In the utility mode, the drawer is pulled out to an extent exposing the cosmetic supply and aligning the mirror with the window. Detent means are provided to maintain the compact in either mode.

U.S. Pat. No. 4,526,273, issued to Tsuji et al., discloses a portable cosmetics case includes a hollow and flat box-like case body. The case body has an opening at one end which opens downwardly. A plurality of cosmetic containers containing e.g. lipsticks, a compacted powder case, and a painting brush are inserted in the case body.

Each cosmetic container has an end portion closing the opening in the case body. Thus, the cosmetics case has a smooth box-like external appearance. The cosmetic containers received in the case body can be replaced as desired according to the user's preference.

U.S. Patent Application Publication No.: 2003/0000865, by Carlino, discloses a cosmetic carrier attachment for an electronic communications device includes a housing for retaining cosmetics and various configurations and elements for removably attaching the housing to the electronic communications device. One configuration includes a lip member attached to the back of the communications device and a channel contained within the back of the housing for engaging the lip member.

The inventions heretofore known suffer from a number of disadvantages which include being limited in use, being limited in application, being limited in compatibility, being expensive, being bulky, being difficult to use, being cumbersome to use, being limited in capability, being limited in functionality, being limited in design, being inappropriate for dispensing cosmetics, failing to facilitate dispensing of a plurality of diverse substances, requiring too many accessories for proper function, being unsightly, having limited utility, being messy, failing to promote organization, being difficult to reach, being limited in decorate-ability, being useful only on initial purchase, not interoperating with other devices, being too thick, taking too long to use/find/clean, bulging when stored in tight spaces (such as but not limited to pockets, bras, belts, bathing suits, and the like), having portions or pieces (like caps) that are easily lost, and the like.

What is needed is a dispensing apparatus that solves one or more of the problems described herein and/or one or more problems that may come to the attention of one skilled in the art upon becoming familiar with this specification.

### SUMMARY OF THE INVENTION

The present invention has been developed in response to the present state of the art, and in particular, in response to the problems and needs in the art that have not yet been fully solved by currently available cosmetic dispensing apparatuses. Accordingly, the present invention has been developed to provide a multi-functional cosmetic dispensing apparatus.

According to one embodiment of the invention, there is a dispensing apparatus that may be configured to contain a dispensable product and may facilitate the storage and dispensing thereof. The dispensing apparatus may include a flat elongated housing that may be configured to house a dispensable product within an interior chamber therein.

The dispensing apparatus may include a minor-like finish that may be disposed on an exterior surface of the housing. The dispensing apparatus may include a dispensing mechanism that may be coupled to the housing and may be configured to selectably urge product stored within the interior chamber out of the housing. The dispensing mechanism may include a paddle that may be disposed within the interior chamber of the housing. The dispensing mechanism may include a screw that may be coupled to the paddle. The dispensing mechanism may include a threaded shaft that may be functionally coupled to the paddle and may be fixedly coupled to a longitudinally flat head. The dispensing mechanism may include a dispensing nozzle that may have a completely circular surface.

The dispensing apparatus may include a cap that may be coupled at a dispensing end of the housing and may be configured to selectably cover and uncover the dispensing end. The cap may be pivotally coupled to the dispensing end of the housing. The dispensing apparatus may include an attachment structure that may be disposed on an end of the housing opposite the dispensing end and may be configured to selectably attach to a coupling member. The attachment structure is disposed within a longitudinally flat head. The attachment structure may be disposed within a receiving cavity of the longitudinally flat head and may include a protrusion that may be extending between walls of the cavity. The dispensing apparatus may include a container that may have an array of coupling member that may be disposed along a first interior end and may be configured to selectably couple to a plurality of dispensing apparatuses. The plurality of dispensing apparatuses may be disposed within the container.

The dispensing apparatus may include a necklace that may have a coupling device attached thereto. The coupling device may be selectably coupled to the attachment structure. The dispensing apparatus may include a dispenser that may be selected from the group of dispensers consisting of: a shaft coupled to the cap, a dabber, an atomizer, a metal rolling ball applicator, a mascara tip coupled to a shaft coupled to the cap, a eyeliner tip coupled to a shaft coupled to the cap, or an aperture.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order for the advantages of the invention to be readily understood, a more particular description of the invention briefly described above will be rendered by reference to specific embodiments that are illustrated in the appended drawing(s). It is noted that the drawings of the invention are not to scale. The drawings are mere schematics representations, not intended to portray specific parameters of the invention. Understanding that these drawing(s) depict only typical embodiments of the invention and are not, therefore, to be considered to be limiting its scope, the invention will be described and explained with additional specificity and detail through the use of the accompanying drawing(s), in which:

FIG. 1 is a side perspective view of a plurality of dispensing apparatuses disposed within a container, according to one embodiment of the invention;

FIG. 2 is a perspective view of a dispensing apparatus selectably coupled to a container, according to one embodiment of the invention;

FIG. 3 is a perspective view of a plurality of dispensing apparatuses disposed within a container, according to one embodiment of the invention;

FIG. 4 is top plan view of an exterior surface of a dispensing apparatus, according to one embodiment of the invention;

FIG. 5 is a top plan view of an interior of a dispensing apparatus, according to one embodiment of the invention;

FIG. 6 is a side elevational view of a dispensing apparatus, according to one embodiment of the invention;

FIG. 7 is a front perspective view of a dispensing apparatus, according to one embodiment of the invention;

FIG. 8 is a perspective view of a dispensing apparatus, according to one embodiment of the invention;

FIG. 9 is a perspective view of a dispensing apparatus, according to one embodiment of the invention;

FIG. 10 is a perspective view of a dispensing apparatus, according to one embodiment of the invention;

FIG. 11 is a perspective view of a dispensing apparatus coupled to a necklace, according to one embodiment of the invention; and

FIG. 12 is a pair of partial top plan views of an interior of a dispensing apparatus illustrating coupling a member to the illustrated apparatus, according to one embodiment of the invention.

### DETAILED DESCRIPTION OF THE INVENTION

For the purposes of promoting an understanding of the principles of the invention, reference will now be made to the exemplary embodiments illustrated in the drawing(s), and specific language will be used to describe the same. It will nevertheless be understood that no limitation of the scope of the invention is thereby intended. Any alterations and further modifications of the inventive features illustrated herein, and any additional applications of the principles of the invention as illustrated herein, which would occur to one skilled in the relevant art and having possession of this disclosure, are to be considered within the scope of the invention. Reference throughout this specification to an “embodiment,” an “example” or similar language means that a particular feature, structure, characteristic, or combinations thereof described in connection with the embodiment is included in at least one embodiment of the present invention. Thus, appearances of the phrases an “embodiment,” an “example,” and similar language throughout this specification may, but do not necessarily, all refer to the same embodiment, to different embodiments, or to one or more of the figures. Additionally, reference to the wording “embodiment,” “example” or the like, for two or more features, elements, etc. does not mean that the features are necessarily related, dissimilar, the same, etc.

Each statement of an embodiment, or example, is to be considered independent of any other statement of an embodiment despite any use of similar or identical language characterizing each embodiment. Therefore, where one embodiment is identified as “another embodiment,” the identified embodiment is independent of any other embodiments characterized by the language “another embodiment.” The features, functions, and the like described herein are considered to be able to be combined in whole or in part one with another as the claims and/or art may direct, either directly or indirectly, implicitly or explicitly.

As used herein, “comprising,” “including,” “containing,” “is,” “are,” “characterized by,” and grammatical equivalents thereof are inclusive or open-ended terms that do not exclude additional unrecited elements or method steps. “Comprising” is to be interpreted as including the more restrictive terms “consisting of” and “consisting essentially of.”

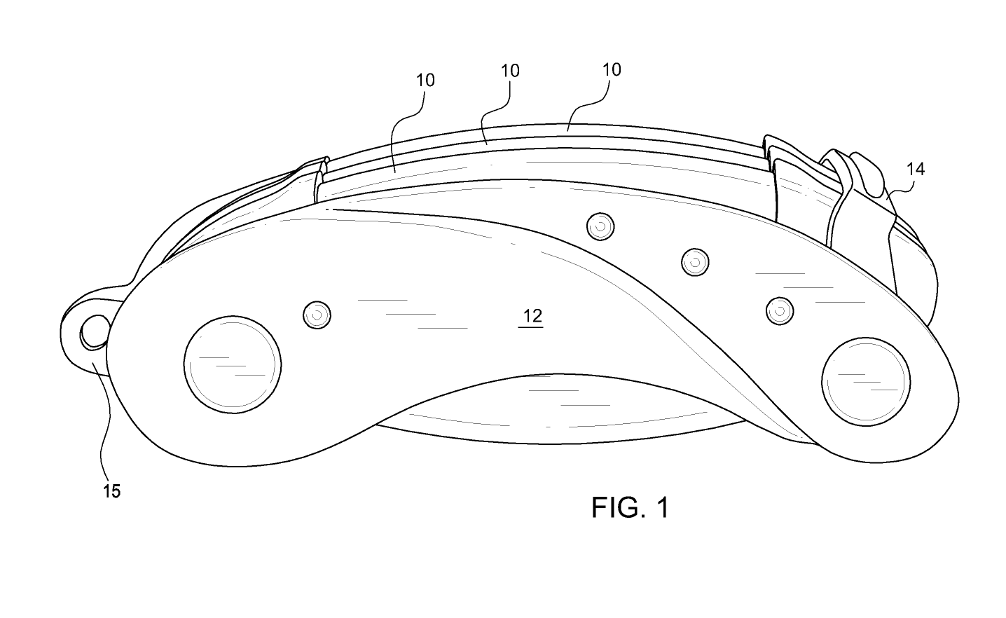

FIG. 1 is a perspective view of a plurality of dispensing apparatuses disposed within a container, according to one embodiment of the invention. There is shown a plurality of dispensing apparatuses 10 disposed within a container 12. The illustrated container 12 does not fully enclose the dispensing apparatuses 10 but maintains close special relationship of the plurality of dispensing apparatuses 12 such that they may be carried together.

The illustrated dispensing apparatuses 10 are configured to contain a dispensable product and facilitate the storage and dispensing thereof. Non-limiting examples of a dispensable product may be fluids, gels, powders, creams, oils, granules, and the like and combinations thereof such as but not limited to lipstick, lip gloss, concealer, foundation, lotions, sunscreens, hair products, powders, creams, liquids, essential oils, perfumes, lotions, brushes, cosmetic applicators, paint, dyes, fragrances, flavorings, candy, medicine, and etc. The dispensing apparatuses are disposed within a container 12. The container 12 substantially encloses and secures the dispensing apparatuses 10 therein. The container 12 includes a securing device 14 configured to pivotally secure over the plurality of dispensing apparatuses 10 and thereby secure the dispensing apparatuses 10 substantially within the container 12. The illustrated securing device is a U-shaped member pivotally coupled to the container across ends of the dispensing apparatuses such that it may be pivoted to be in the way or retraction/pivoting of the same or out of the way. Accordingly a user may selectably secure such thereby.

The illustrated container 12 is shaped substantially like a pocket knife or a Swiss Army style knife, wherein the dispensing apparatuses may be similar to the fold-out blades or fold-out tools. The container 12 includes an attachment loop 15 configured to selectably attach the container 12 to a user or an attachment device. Non-limiting examples of an attachment device may be an elongated member, such as a string, a necklace, a bracelet, a chain, a keychain, etc.

Advantageously, a user may carry a plurality of dispensing apparatuses holding a plurality of contents in a convenient and safe manner, wherein the dispensing apparatuses are selectably available for use when desired. This provides a convenient storage and use for users.

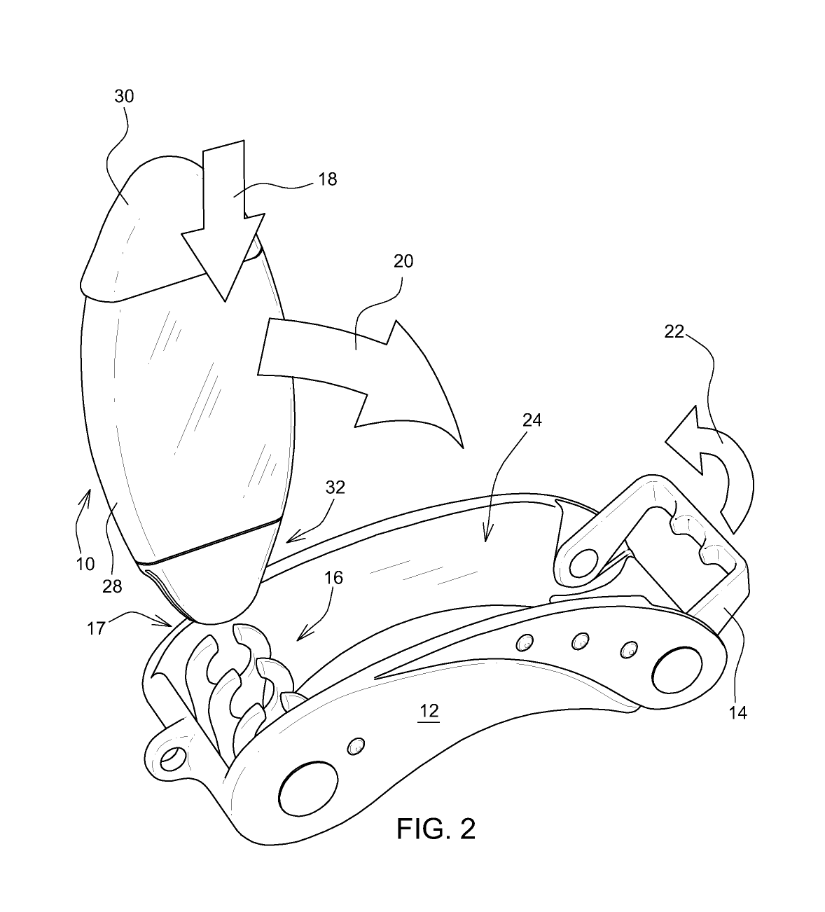

FIG. 2 is a perspective view of a dispensing apparatus selectably coupled to a container, according to one embodiment of the invention. There is shown a dispensing apparatus 10 selectably coupleable to a container 12. The illustration shows how a user may couple a dispensing apparatus to a container by engaging matched coupling members and rotating the dispensing apparatus to an enclosed position. Accordingly, a dispensing apparatus may be selectably attached/released for convenient storage and use.

The illustrated dispensing apparatus 10 include a flat elongated housing 28 configured to house a dispensable product. The dispensing apparatus 10 includes a cap 30 configured to selectably cover and uncover a dispensing end. The cap 30 also secures the dispensable product within the housing 28. The dispensing apparatus 10 includes an attachment structure 32 disposed on an end of the housing 28 opposite the cap 30 and the dispensing end. The attachment structure 32 is configured to selectably attach to a coupling member 16. The dispensing apparatus 10 is selectably coupled to a container 12 having an array of coupling member 16 disposed along a first interior end 17 and configured to selectably couple to the attachment structure 32 of a plurality of dispensing apparatuses 10. The plurality of dispensing apparatuses 10 are disposed within an interior cavity 24 of the container 12.

The attachment structure 32 of the dispensing apparatus 10 is configured to couple to a coupling member 16 of a container 12. The illustrated dispensing apparatus 10 is disposed in a downward position 18, wherein the attachment structure 32 is disposed onto the coupling member 16. The attachment structure 32 is configured to pivot 20 about the coupling member 16 and rest within the interior cavity 24 of the container 12. The container 12 includes a securing device 14 configured to pivotally secure a dispensing apparatus 10 or a plurality of dispensing apparatuses within the container 12. The mating members 32 and 16 are shaped and positioned such that when the attachment structure 32 is rotated with respect to the coupling member 16 the two fully engage such that the dispensing apparatus is firmly attached to the container. The securing device 14 is configured to pivotally secure over 22 the dispensing apparatus 10 and thereby secure the dispensing apparatus 10 substantially within the container 12.

Wherein dispensing apparatuses may be selectively removed from the container as desired, a user may have a multiplicity of dispensing apparatuses with a great variety of contents and may therefore customize the carried dispensing apparatuses at any time, thereby permitting the user to be very organized while minimizing weight and bulk carried at any given moment/event.

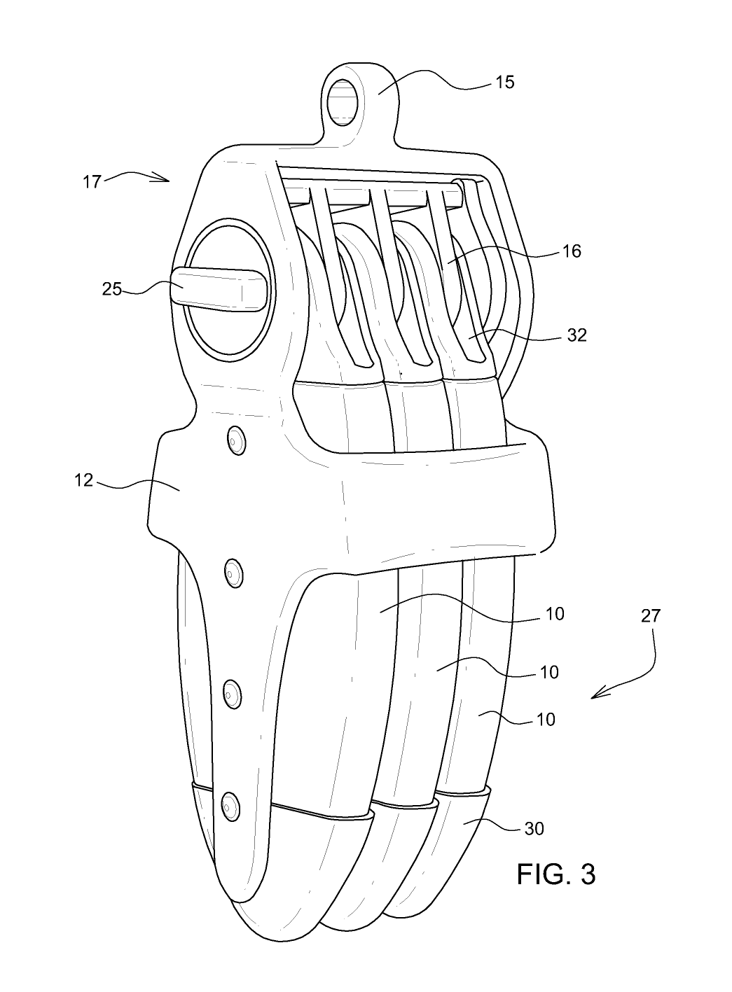

FIG. 3 is a perspective view of a plurality of dispensing apparatuses disposed within a container, according to one embodiment of the invention. There is shown a plurality of dispensing apparatuses 10 disposed within a container 12.

The illustrated plurality of dispensing apparatuses 10 are configured to contain a dispensable product and facilitate the storage and dispensing thereof. Non-limiting examples of a dispensable product may be lipstick, lip gloss, concealer, foundation, lotions, sunscreens, hair products, powders, creams, liquids, oils, brushes, cosmetic applicators, etc. The plurality of dispending apparatuses 10 each include a cap 30 configured to facilitate the dispensing of the dispensable product. The plurality of dispensing apparatuses 10 are disposed within a container 12. The container 12 substantially encloses and secures the dispensing apparatuses 10 therein. The container 12 includes a locking device 25 configured to secure the plurality of dispensing apparatuses 10 within an interior of the container 12. The illustrated container 12 is shaped substantially open, wherein a bottom end is open 27. The container 12 includes a plurality of coupling members 16 disposed on a first interior end 17 configured to selectably couple to a plurality of dispensing apparatuses 10. The coupling members 16 are configured to couple to an attachment structure 32 of the dispensing apparatus 10. The dispensing apparatus 10 is configured to be disposed through the open end 27 of the container 12 and secure the attachment structure 32 onto the coupling member 16. The container 12 includes a locking device 25 configured to secure the attachment structure 32 of the dispensing apparatuses 10 to the coupling member 16 of the container 12. The locking device 25 may include a rotatable flange or other structure that may engage and/or block a coupling structure of a dispensing apparatus such that the apparatus may be locked into place (pivotally and/or laterally) and thereby prevented from undesired motion relative to the container.

The container 12 includes an attachment loop 15 configured to selectably attach the container 12 to a user or an attachment device. Non-limiting examples of an attachment device may be an elongated member, such as a string, a necklace, a bracelet, a chain, a keychain, etc.

FIG. 4 is top plan view of an exterior surface of a dispensing apparatus, according to one embodiment of the invention. There is shown dispensing apparatus including a cap 30. FIGS. 4-6 illustrate different views of an identical dispensing apparatus having a low aspect ratio (flat) and substantially symmetrical elliptical shape. Advantageously, the flat shape permits more convenient storage and facilitates a pivotally coupled cap to operate without difficulty.

The illustrated dispensing apparatus 10 is configured to contain a dispensable product and facilitate the storage and dispensing thereof. The dispensing apparatus 10 includes a flat elongated housing 28 configured to house a dispensable product. The dispensing apparatus 10 includes a mirror-like finish 36 disposed on an exterior surface of the housing 28. Such may include but is not limited to: a glass or plastic based mirror having a back coating of a reflective material, a layer of highly reflective material such as but not limited to chrome or metal foil that is coupled to an exterior surface of the dispensing apparatus, and/or a high gloss surface treatment/buffing of a region of the exterior surface. Such a surface may be advantageously utilized as a touch-up minor.

The dispensing apparatus 10 includes a cap 30 coupled at a dispensing end 40 of the housing 28. The illustrated cap 30 is coupled to the body of the dispensing apparatus at a position off-center to the central axis of the body such that it is configured to selectably cover and uncover the dispensing end 40 by rotating away from the covered surface. Advantageously, such a cap is not susceptible to being lost.

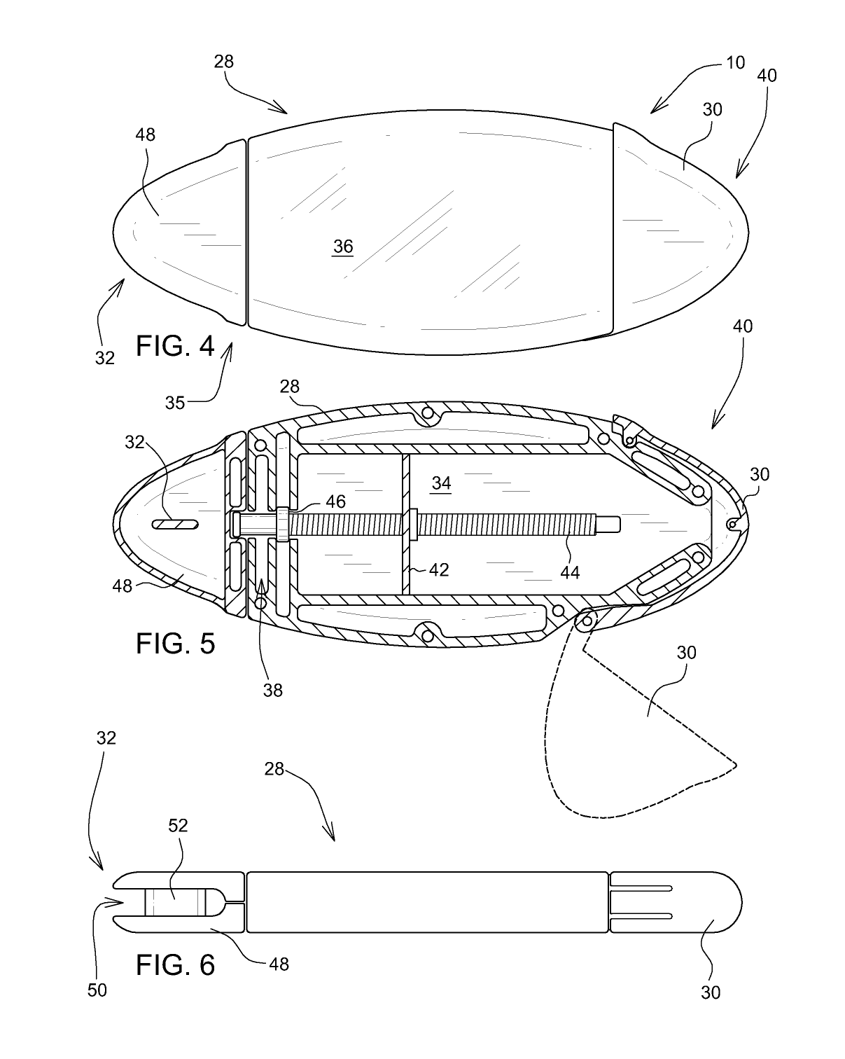

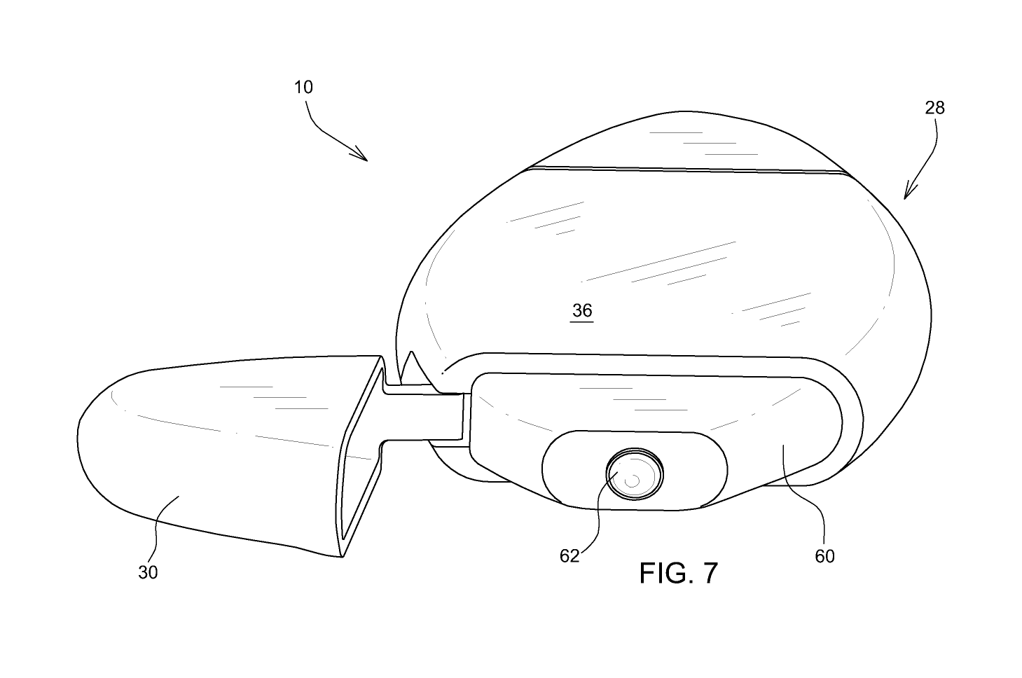

The dispensing apparatus 10 includes an attachment structure 32 disposed on an end 35 of the housing 12 opposite the dispensing end 40. The attachment structure 32 is configured to selectably attach to a coupling member of a container. The attachment structure 32 is disposed within a longitudinally flat head 48 having a receptacle and/or cavity (See FIGS. 5 and 6) disposed therein with an attachment member (See FIG. 5) configured to mate to another structure, thereby permitting coupling thereto.

FIG. 5 is a top plan view of an interior of a dispensing apparatus, according to one embodiment of the invention. There is shown a cross-section of a dispensing apparatus 10 including an interior chamber 34 and structure disposed therein configured to effectuate selectable dispensing of the contents thereof.

The illustrated dispensing apparatus 10 is configured to contain a dispensable product and facilitate the storage and dispensing thereof. The dispensing apparatus 10 includes a flat elongated housing 28 configured to house a dispensable product within an interior chamber 34 therein. The dispensing apparatus 10 includes a dispensing mechanism 38 coupled to the housing 28 and configured to selectably urge product stored within the interior chamber 34 out of the housing 28.

The illustrated dispensing mechanism 38 includes a paddle 42 disposed within the interior chamber 34 of the housing 28. The illustrated paddle is an elongated planar member having a threaded aperture therethrough whereby it is coupled to a shaft 44. The paddle is shaped and sized to substantially divide the interior chamber into two portions having substantially no communication therebetween sufficient to keep material in the two sections from passing back and forth according to desired tolerances which may change according to the contents and desired results. There may be a fluid/powder/gas tight seal between the paddle and interior walls of the chamber and such may be effectuated by materials and sizing that accomplishes the same.

The illustrated dispensing mechanism 38 includes a screw 46 coupled to the paddle 42. The dispensing mechanism 38 includes a threaded shaft 44 that functionally couples to the paddle 42 and is fixedly coupled to a longitudinally flat head 48 of the attachment structure 32. The longitudinally flat head 48 is shaped much like the head of a thumb operated such that a user may manipulate the flat head to effectuate rotation of the screw and thereby change a position of the paddle. Changing a position of the paddle may reduce an effective volume of a chamber of the interior chamber, which may in turn force fluid/powder/granules/gels or the like out an exit of the interior chamber thereby dispensing the material. This operation is similar to some deodorant dispensers and the like.

The illustrated dispensing apparatus 10 includes a cap 30 coupled at a dispensing end 40 of the housing 28 and configured to selectably cover and uncover the dispensing end 40. The illustrated cap 30 is pivotally coupled to the dispensing end 40 of the housing 28.

The illustrated dispensing aperture opposite the flat head 48 includes inwardly curved surfaces the permit a user to apply contents to a surface by pushing the tip directly against the surface (such as but not limited to skin (lips, cheeks, etc.)) without requiring the contents to be dispensed a distance outside the chamber while preventing the aperture from scratching or otherwise damaging the surface. Further, the exterior surface of the aperture may be cleaned without substantial contamination of the contents of the chamber.

FIG. 6 is a side elevational view of a dispensing apparatus, according to one embodiment of the invention. There is shown a dispensing apparatus 10 including an attachment structure 32.

The illustrated dispensing apparatus 10 includes a flat elongated housing 28 configured to house a dispensable product. The dispensing apparatus 10 includes a longitudinally flat head 48 disposed at an end of the housing 28. The dispensing apparatus 10 includes a cap 30 coupled at a dispensing end of the housing 28, opposite of the longitudinally flat head 48 and configured to selectably cover and uncover the dispensing end.

The dispensing apparatus 10 includes an attachment structure 32 that may be disposed on an end of the housing 28 opposite the dispensing end and configured to selectably attach to a coupling member of a container, such as but not limited to a C-clip structure. The attachment structure 32 is disposed within a longitudinally flat head 48. The attachment structure 32 is disposed within a receiving cavity 50 of the longitudinally flat head 48 and includes a protrusion 52 extending between walls of the cavity 50.

FIG. 7 is a front perspective view of a dispensing apparatus, according to one embodiment of the invention. There is shown a dispensing apparatus 10 including dispensing nozzle 60.

The illustrated dispensing apparatus 10 is configured to contain a dispensable product and facilitate the storage and dispensing thereof. The dispensing apparatus 10 includes a flat elongated housing 28 configured to house a dispensable product. The dispensing apparatus 10 includes a mirror-like finish 36 disposed on an exterior surface of the housing 28. The dispensing apparatus 10 includes a dispensing mechanism coupled to the housing 28 and configured to selectably urge product stored within the housing out thereof. The dispensing mechanism includes a dispensing nozzle 60 having a metal ball applicator 62 configured to apply a liquid smoothly to a surface. The dispensing apparatus 10 includes a cap 30 pivotally coupled to the housing 28 and may be configured to selectably cover and uncover the dispensing nozzle 60.

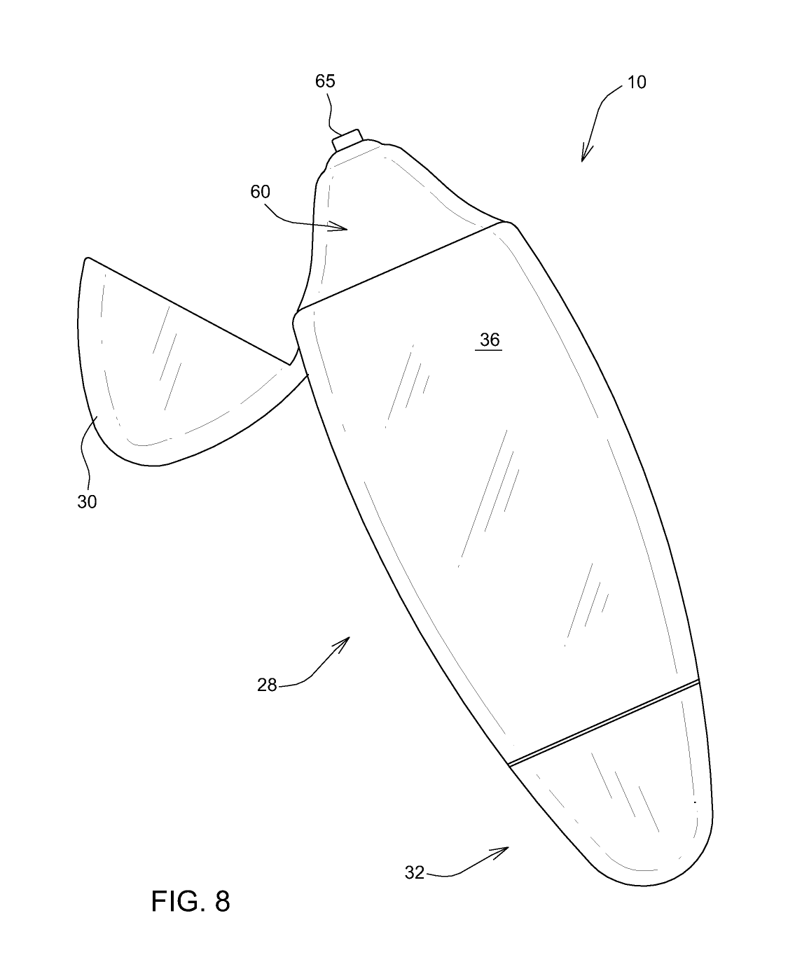

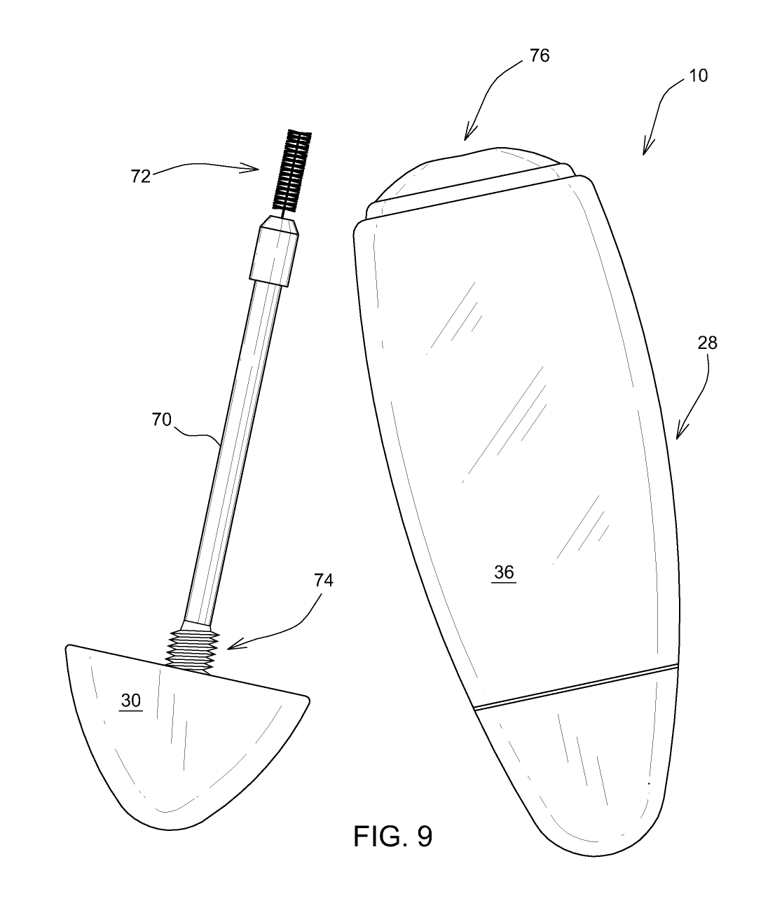

FIG. 8 is a perspective view of a dispensing apparatus, according to one embodiment of the invention. There is shown a dispensing apparatus 10 including a minor-like finish 36 on an exterior surface of a flat elongated housing 28.

The illustrated dispensing apparatus 10 is configured to contain a dispensable product and facilitate the storage and dispensing thereof. The dispensing apparatus 10 includes a flat elongated housing 28 configured to house a dispensable product. The dispensing apparatus 10 includes a mirror-like finish 36 disposed on an exterior surface of the housing 28. The dispensing apparatus 10 includes a dispensing mechanism coupled to the housing 28 and configured to selectably urge product stored within the housing out thereof. The dispensing mechanism includes a dispensing nozzle 60 having a completely circular surface 65 configured to apply a dispensable product onto a surface. The dispensing apparatus 10 includes a cap 30 pivotally coupled to the housing 28 and may be configured to selectably cover and uncover the dispensing nozzle 60. The flat elongated housing 28 includes an attachment structure 32 configured to selectably couple the dispensing apparatus 10 to a container.

FIG. 9 is a perspective view of a dispensing apparatus, according to one embodiment of the invention. There is shown a dispensing apparatus 10 including a removable cap 30.

The illustrated dispensing apparatus 10 is configured to contain a dispensable product and facilitate the storage and dispensing thereof. The dispensing apparatus 10 includes a flat elongated housing 28 configured to house a dispensable product. The dispensing apparatus 10 includes a mirror-like finish 36 disposed on an exterior surface of the housing 28. The dispensing apparatus 10 includes a dispensing mechanism coupled to the housing 28 and having an aperture 76 to access a dispensable product stored within an interior chamber of the housing 28. The dispensing mechanism includes a shaft 70 coupled to a removable cap 30 of the dispensing apparatus 10. The shaft 70 includes a threaded attachment member 74 configured to secure to the removable cap 30. The shaft 70 is coupled to an attachment applicator. The illustrated attachment applicator is a mascara applicator 72 configured to apply a dispensable product upon eyelashes.

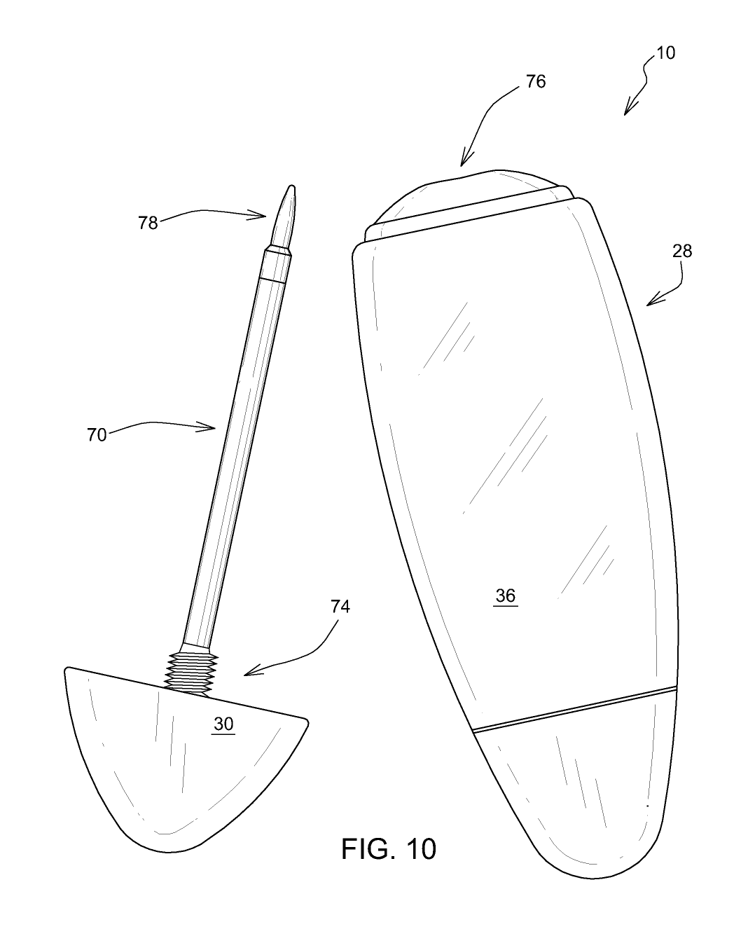

FIG. 10 is a perspective view of a dispensing apparatus, according to one embodiment of the invention. There is shown a dispensing apparatus 10 including a removable cap 30.

The illustrated dispensing apparatus 10 is configured to contain a dispensable product and facilitate the storage and dispensing thereof. The dispensing apparatus 10 includes a flat elongated housing 28 configured to house a dispensable product. The dispensing apparatus 10 includes a mirror-like finish 36 disposed on an exterior surface of the housing 28. The dispensing apparatus 10 includes a dispensing mechanism coupled to the housing 28 and having an aperture 76 to access a dispensable product stored within an interior chamber of the housing 28. The dispensing mechanism includes a shaft 70 coupled to a removable cap 30 of the dispensing apparatus 10. The shaft 70 includes a threaded attachment member 74 configured to secure to the removable cap 30. The shaft 70 is coupled to an attachment applicator. The illustrated attachment applicator is a eyeliner applicator 78 configured to apply a dispensable product upon an eye region.

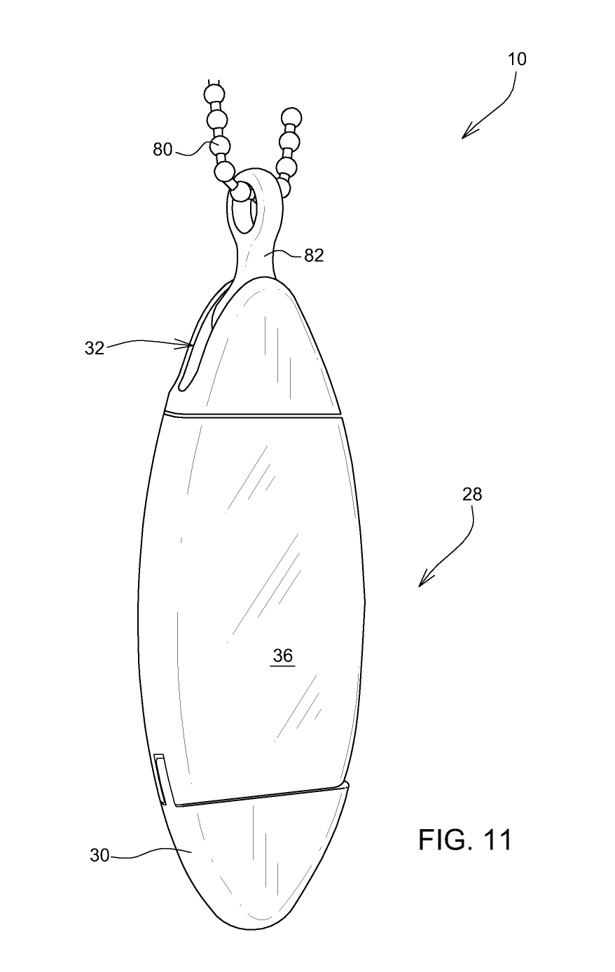

FIG. 11 is a perspective view of a dispensing apparatus coupled to an elongated member, according to one embodiment of the invention. There is shown a dispensing apparatus 10 coupled to a necklace 80 (partial view thereof).

The illustrated dispensing apparatus 10 is configured to contain a dispensable product and facilitate the storage and dispensing thereof. The dispensing apparatus 10 includes a flat elongated housing 28 configured to house a dispensable product. The dispensing apparatus 10 includes a mirror-like finish 36 disposed on an exterior surface of the housing 28. The dispensing apparatus 10 includes a cap 30 pivotally coupled to the housing 28. The dispensing apparatus 10 includes an attachment structure 32 disposed on an end of the housing 28 and configured to selectably attach to a coupling device 82. The dispensing apparatus 10 is coupled to a necklace 80 configured to be worn about a neck area of a user.

Advantageously, a user may carry the dispensing apparatus out in the open as a visible accessory instead of hiding the same in a purse, bag, or pocket. This permits more facile use thereof and permits double function of the apparatus.

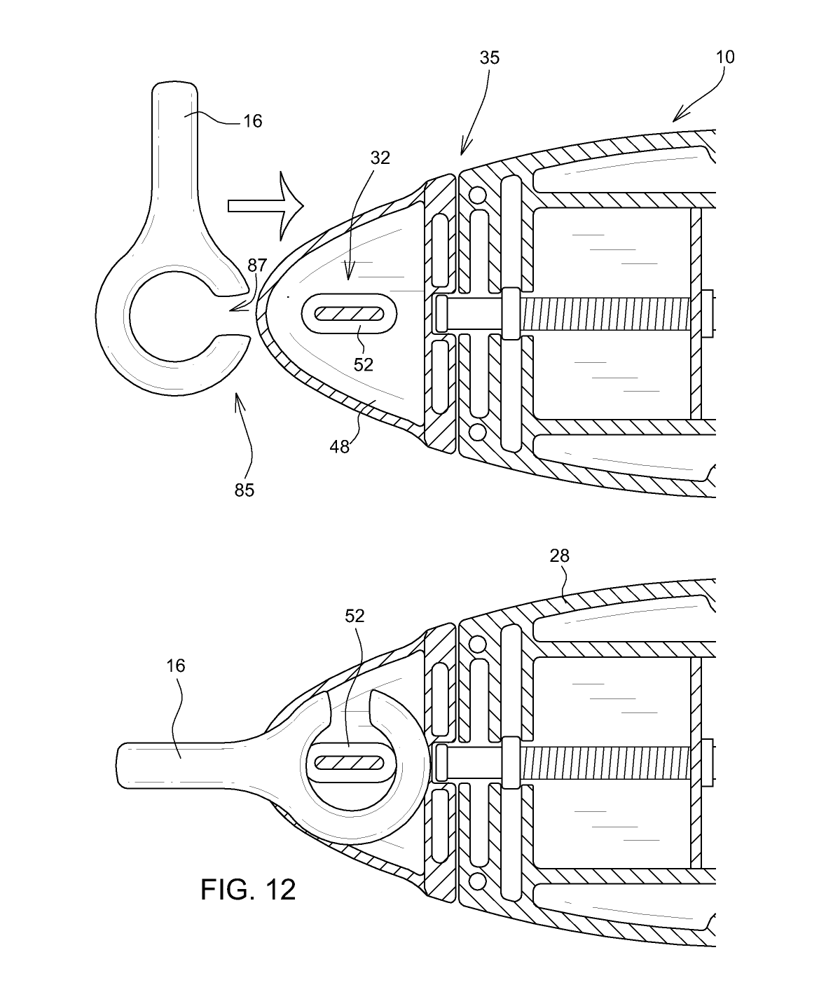

FIG. 12 is a pair of partial top plan cross-sectional views of an interior of a dispensing apparatus showing coupling of the apparatus to a coupling member, according to one embodiment of the invention. There is shown a dispensing apparatus 10 including an attachment structure 32.

The illustrated dispensing apparatus 10 is configured to contain a dispensable product and facilitate the storage and dispensing thereof. The dispensing apparatus 10 includes a flat elongated housing 28 configured to house a dispensable product therein. The dispensing apparatus 10 includes an attachment structure 32 disposed on an end 35 of the housing 28 and configured to selectably attach to a coupling member 16 (illustrated as a C-clip) of a container, a coupling device, a necklace, or another structure. The attachment structure 32 includes a longitudinally flat head 48. The attachment structure 32 includes a receiving protrusion 52 configured to couple attachment arm 85 of a coupling member of a container. The illustrated attachment arm 85 includes a receiving aperture 87 configured to receive the receiving protrusion 52 of the coupling member 16. The attachment arm 85 secures about the receiving protrusion 52 and rotates thereabout, thereby securing the attachment structure 32 and the dispensing apparatus 10 to a coupling member 16 of a container.

It is understood that the above-described embodiments are only illustrative of the application of the principles of the present invention. The present invention may be embodied in other specific forms without departing from its spirit or essential characteristics. The described embodiment is to be considered in all respects only as illustrative and not restrictive. The scope of the invention is, therefore, indicated by the appended claims rather than by the foregoing description. All changes which come within the meaning and range of equivalency of the claims are to be embraced within their scope.

For example, although an embodiment of the invention is likely to be produced and marketed to a female demographic, it is understood that male-centric, child-centric, baby/toddler-centric, sport-centric, pet-centric, and the like versions may be produced that fall within the scope of the claims. Additionally, although the figures illustrate a particular dispensing mechanism in

FIG. 5, it is understood that other mechanisms may be utilized such as but not limited to mechanisms used in lipstick dispensers, lip balm dispensers, squeeze/type dispensers, ratcheting dispensers, spring loaded dispensers, pressurized gas dispensers, and the like and combinations thereof. Further, an apparatus may include one or more of the following devices in combination with or instead of a chamber: music player, camera, computer memory, ultrasonic blemish remover, vibrator, massager, mace, dental care tools, hair products, flashlight, temperature gauge, pressure gauge, clock, magnifier, and the like, combinations thereof and etc.

It is also envisioned that characteristics of embodiments of the invention may vary, including but not limited to being: water-resistant, water-proof, very rugged, being branded, and the like and combinations thereof.

Additionally, a dispensing apparatus may include a light (LED, incandescent, etc.) coupled to a power source (battery, power supply, solar cell, etc.) that may be disposed on, near, over, and/or about an exterior surface, interior surface, handle, cap, aperture, or other feature/structure/member of the apparatus or container.

More, it is envisioned that a dispensing apparatus may include removable plates/skins/etc. on an exterior surface such that the apparatus may be redecorated as desired with a plurality of decorative members. Such members may selectably couple to an exterior of the apparatus by tongue and groove, hook and loop, friction fit, adhesive, and the like and combinations thereof and may exist as a layer of decorative material on an exterior surface of the apparatus.

It is further envisioned that there may be a cartridge system wherein a cavity/chamber may receive a selectably removably cartridge that may include its own dispensing aperture/device/system/mechanism such that a same dispensing apparatus may be used together with a plurality of contents. The dispensing apparatus may include a coupling or locking mechanism that may engage with a cartridge and/or may include a button or other device for selectably removing and/or locking the cartridge in place.

It is expected that there could be numerous variations of the design of this invention. An example is that the profile may be a shape other than a substantially symmetrical ellipse, such as but not limited to circular, egg-shaped, rectangular, oblong, polygonal, irregularly shaped, and the like and combinations thereof.

Finally, it is envisioned that the components of the device may be constructed of a variety of materials, including but not limited to metal, wood, ceramic, mineral, fiber, micro-fiber, plastic, resin, composite, leather, and the like and composites thereof. As one non-limiting example, there may be a dispensing apparatus including high strength materials (e.g. titanium and/or metal alloys, carbon fiber, etc.) such as but not limited to materials used in high performance vehicles (aircraft, competition cycles, and etc.) such that one or more components of the dispensing apparatus and/or cartridges thereof may be made much smaller/thinner/lighter than may otherwise be possible thereby enhancing the convenience, storability, ratio of content to container, and the like and combinations thereof.

Thus, while the present invention has been fully described above with particularity and detail in connection with what is presently deemed to be the most practical and preferred embodiment of the invention, it will be apparent to those of ordinary skill in the art that numerous modifications, including, but not limited to, variations in size, materials, shape, form, function and manner of operation, assembly and use may be made, without departing from the principles and concepts of the invention as set forth in the claims. Further, it is contemplated that an embodiment may be limited to consist of or to consist essentially of one or more of the features, functions, structures, methods described herein.

What is claimed is:

1. A dispensing apparatus configured to contain a dispensable product and facilitate the storage and dispensing thereof, comprising:
a) a flat elongated housing configured to house a dispensable product within an interior chamber therein;
b) a mirror-like finish disposed on an exterior surface of the housing;
c) a dispensing mechanism coupled to the housing and configured to selectably urge product stored within the interior chamber out of the housing;
d) a cap coupled at a dispensing end of the housing and configured to selectably cover and uncover the dispensing end; and
e) an attachment structure disposed on an end of the housing opposite the dispensing end and configured to selectably attach to a coupling member.

2. The apparatus of claim 1, wherein the dispensing mechanism includes:
a) a paddle disposed within the interior chamber of the housing; and
b) a screw coupled to the paddle and including a threaded shaft functionally coupled the paddle and fixedly coupled to a longitudinally flat head.

3. The apparatus of claim 1, wherein the attachment structure is disposed within the longitudinally flat head.

4. The apparatus of claim 1, wherein the attachment structure is disposed within a receiving cavity of the longitudinally flat head and includes a protrusion extending between walls of the cavity.

5. The apparatus of claim 1, wherein the dispensing mechanism includes a dispensing nozzle having a completely circular surface.

6. The apparatus of claim 1, wherein the cap is pivotally coupled to the dispensing end of the housing.

7. The apparatus of claim 1, further comprising a necklace having a coupling device attached thereto; wherein the coupling device selectably couples to the attachment structure.

8. The apparatus of claim 1, wherein the dispensing mechanism includes a dispenser selected from the group of dispensers consisting of: a shaft coupled to the cap, a dabber, an atomizer, a metal rolling ball applicator, a mascara tip coupled to a shaft coupled to the cap, a eyeliner tip coupled to a shaft coupled to the cap, an aperture.

9. A dispensing apparatus configured to contain a dispensable product and facilitate the storage and dispensing thereof, comprising:
a) a flat elongated housing configured to house a dispensable product within an interior chamber therein;
b) a mirror disposed on an exterior surface of the housing;
c) a dispensing mechanism coupled to the housing and configured to selectably urge product stored within the interior chamber out of the housing;
d) a cap coupled at a dispensing end of the housing and configured to selectably cover and uncover the dispensing end;
e) an attachment structure disposed on an end of the housing opposite the dispensing end and configured to selectably attach to a coupling member; and
f) a container having an array of coupling member disposed along a first interior end configured to selectably couple to the attachment structures of a plurality of dispensing apparatuses.

10. The apparatus of claim 9, wherein the dispensing mechanism includes:
a) a paddle disposed within the interior chamber of the housing; and
b) a screw coupled to the paddle and including a threaded shaft functionally coupled the paddle and fixedly coupled to a longitudinally flat head.

11. The apparatus of claim 10, wherein the attachment structure is disposed within the longitudinally flat head.

12. The apparatus of claim 11, wherein the attachment structure is disposed within a receiving cavity of the longitudinally flat head and includes a protrusion extending between walls of the cavity.

13. The apparatus of claim 12, wherein the dispensing mechanism includes a dispensing nozzle having a completely circular surface.

14. The apparatus of claim 13, wherein the cap is pivotally coupled to the dispensing end of the housing.

15. The apparatus of claim 14, further comprising a necklace having a coupling device attached thereto; wherein the coupling device selectably couples to the attachment structure.

16. The apparatus of claim 15, wherein the dispensing mechanism includes a dispenser selected from the group of dispensers consisting of: a shaft coupled to the cap, a dabber, an atomizer, a metal rolling ball applicator, a mascara tip coupled to a shaft coupled to the cap, a eyeliner tip coupled to a shaft coupled to the cap, an aperture.

17. A dispensing apparatus configured to contain a dispensable product and facilitate the storage and dispensing thereof, comprising:
a) a flat elongated housing configured to house a dispensable product within an interior chamber therein;
b) a mirror-like finish disposed on an exterior surface of the housing;
c) a dispensing mechanism coupled to the housing and configured to selectably urge product stored within the interior chamber out of the housing; wherein the dispensing mechanism includes:
c1) a paddle disposed within the interior chamber of the housing;
c2) a screw coupled to the paddle and including a threaded shaft functionally coupled the paddle and fixedly coupled to a longitudinally flat head; and
c3) a dispensing nozzle having a completely circular surface;
d) a cap coupled at a dispensing end of the housing and configured to selectably cover and uncover the dispensing end; wherein the cap is pivotally coupled to the dispensing end of the housing;
e) an attachment structure disposed on an end of the housing opposite the dispensing end and configured to selectably attach to a coupling member; wherein the attachment structure is disposed within the longitudinally flat head; wherein the attachment structure is disposed within a receiving cavity of the longitudinally flat head and includes a protrusion extending between walls of the cavity; and
f) a container having an array of coupling member disposed along a first interior end configured to selectably couple to the attachment structure of a plurality of dispensing apparatuses; wherein the plurality of dispensing apparatuses are disposed within the container.

18. The apparatus of claim 17, further comprising a necklace having a coupling device attached thereto; wherein the coupling device selectably couples to the attachment structure.

19. The apparatus of claim 17, wherein the dispensing mechanism includes a dispenser selected from the group of dispensers consisting of: a shaft coupled to the cap, a dabber, an atomizer, a metal rolling ball applicator, a mascara tip coupled to a shaft coupled to the cap, a eyeliner tip coupled to a shaft coupled to the cap, an aperture.
